(19) United States
(12) Patent Application Publication
(10) Pub. No.: US 2011/0134640 A1
(43) Pub. Date: Jun. 9, 2011

(54) LED LUMINOUS SCREEN, PARTICULARLY FOR MEGA SCREENS

(76) Inventor: Marco Bertele, Lurago d'Erba (IT)

(21) Appl. No.: 13/056,798

(22) PCT Filed: Jul. 29, 2009
(86) PCT No.: PCT/IB09/06429

§ 371 Date: Jan. 31, 2011

(30) Foreign Application Priority Data
Aug. 1, 2008 (IT) MI2008A001438

(51) Int. Cl. F21S 4/00

(52) U.S. Cl. 362/249.02

(57) ABSTRACT

“An LED luminous screen, particularly for mega screens, giant graphical video screens, lighting effects and the like, comprising a plurality of pixels arranged according to an array, each pixel being formed by a plurality of LEDs which are associated with a printed circuit contained in a main body that forms the individual pixel; the screen comprises, for each column of the array, at least one supporting cable that can be fixed between the main bodies or to each one of the main bodies that belong to the same vertical row of the array by way of fixing means and extend substantially at right angles to an upper supporting bar, which can be arranged horizontally; the main bodies belonging to adjacent columns are mutually connectable by way of connection means in order to keep the main bodies substantially on a same plane and at a given distance between the elements.”

### TECHNICAL FIELD

The present invention relates to an LED luminous screen, with video technology, graphics, light effects.

### BACKGROUND OF THE INVENTION

Currently, in order to provide mega screens and/or scoreboards, particularly related to sports competitions, the use of LED luminous screens, both indoor screens and outdoor screens, is widespread.

These screens, which are usually hung so that they are clearly visible from any point of the stands, use a supporting structure which can be rigid or flexible.

Giant video screens are provided:

1. By means of one or more large metallic boxes, which are mutually connected and form a flat and uniform surface inside which the LED cards are placed.
2. By means of horizontal or vertical bar elements, which are mutually separated and connected rigidly or flexibly.
3. Individual pixels or groups of LEDs, which are fixed to a rigid mesh structure.
4. Individual pixels fixed to a large awning that acts as a mechanical support.

As regards item 1) (described above), since they are generally hung, the use of rigid supporting structures in LED luminous screens of the known type can entail an excessive weight of the screen, which accordingly entails the use of considerably large supporting structures in order to support the screen itself.

As regards the screens mentioned above, they all have a rather important opaque surface, which however entails the drawback of not allowing the passage of enough light when they are rested against continuously glazed walls of buildings.

The use of flexible supporting structures, such as for example a large awning, is a step ahead in terms of weight with respect to screens having a rigid supporting structure, but due to the nature of the supporting structure, which typically consists of a sheet or a grid of flexible material on the nodes of which the pixels of the screen are arranged, it entails a loss of stiffness such that the screen can assume unwanted curvatures, thus deforming the projected image.

In both cases, these luminous screens of the known type further suffer the drawback that the generic pixel consists of a complicated LED system which, in the case of maintenance operations, does not allow intervention on the individual LED or on the individual pixel, thus acting on the entire luminous screen.

### BRIEF SUMMARY OF THE INVENTION

The aim of the present invention is to eliminate the drawbacks cited above, by providing an LED luminous screen, particularly for mega screens, that has a modest weight, with a structure that is rigid enough to keep the pixels that form the luminous screen coplanar, minimizing the non-luminous surface in order to maximize transparency if the screen is rested against glazed building surfaces, and minimizing the resistance of the effect of the wind when the screen is free in the air (suspended from: buildings, cables stretched in the air, inflatable balloons, dirigibles, et cetera).

Within this aim, an object of the present invention is to provide an LED luminous screen whose pixels are formed by a plurality of LEDs by means of a simple structure which allows access to the individual LED or pixel, for example in case of maintenance operations, without performing an intervention on the entire screen.

This aim, as well as these and other objects that will become better apparent hereinafter, are achieved by an LED luminous screen, particularly for mega screens, comprising a plurality of pixels arranged according to an array, each pixel being formed by a plurality of LEDs which are associated with a printed circuit contained in a main body that forms the individual pixel, characterized in that it comprises, for each column of said array, at least one supporting cable that can be fixed between the main bodies or to each one of said main bodies that belong to the same row of said array by way of fixing means and extend substantially at right angles to an upper supporting bar which can be arranged horizontally, said main bodies belonging to adjacent columns of said array being mutually connected by way of elastic shape memory means or rigid spacers in order to keep said main bodies substantially on a same plane.

The use of flexible metallic cables to connect the pixels in a vertical direction and of elastic shape memory means to connect the pixels in a horizontal direction further makes it possible, when so desired, to cover both vertically and horizontally rounded surfaces.

### BRIEF DESCRIPTION OF THE DRAWINGS

Further characteristics and advantages of the present invention will become better apparent from the description of a preferred but not exclusive embodiment of an LED luminous screen according to the invention, illustrated by way of non-limiting example in the accompanying drawings, wherein:

FIG. 1 is a partial front elevation view of an embodiment of an LED luminous screen, particularly for mega screens, according to the present invention;

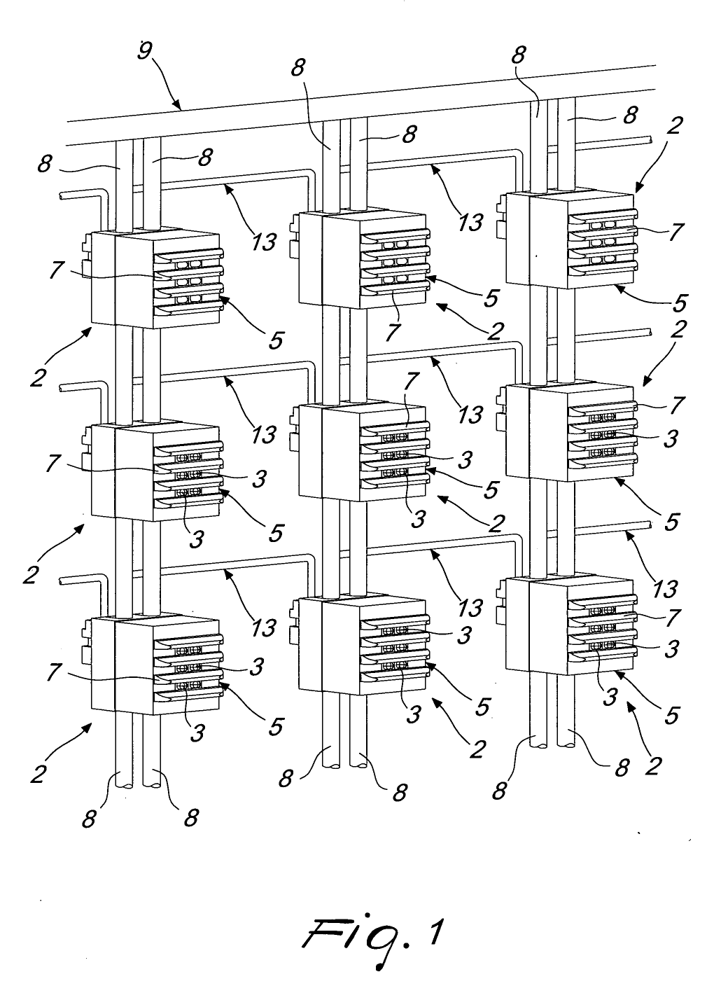

FIG. 2 is a front perspective view of a main body of the LED luminous screen shown in FIG. 1;

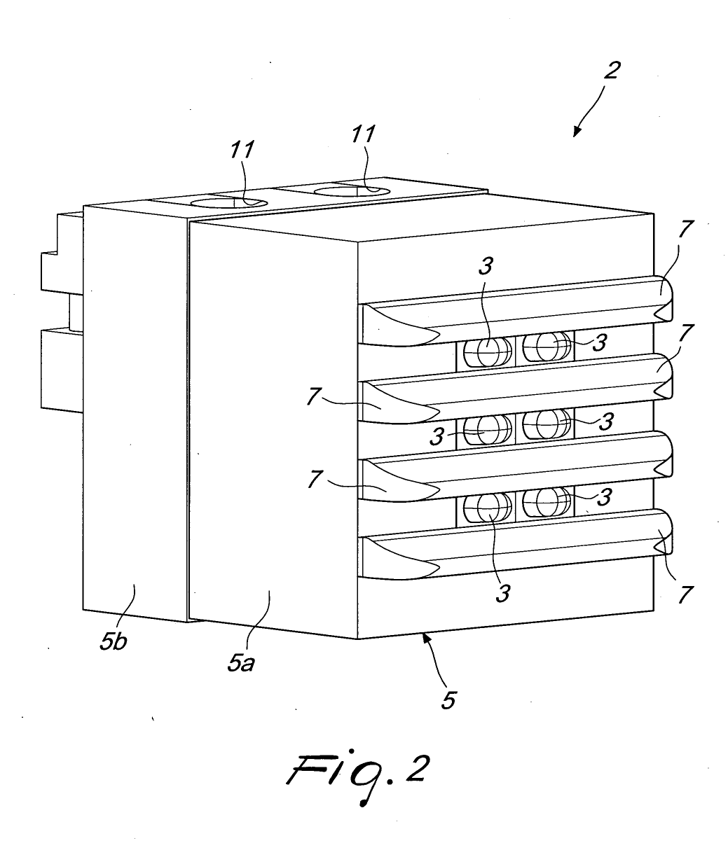

FIG. 3 is a rear perspective view of a main body of the LED luminous screen shown in FIG. 1;

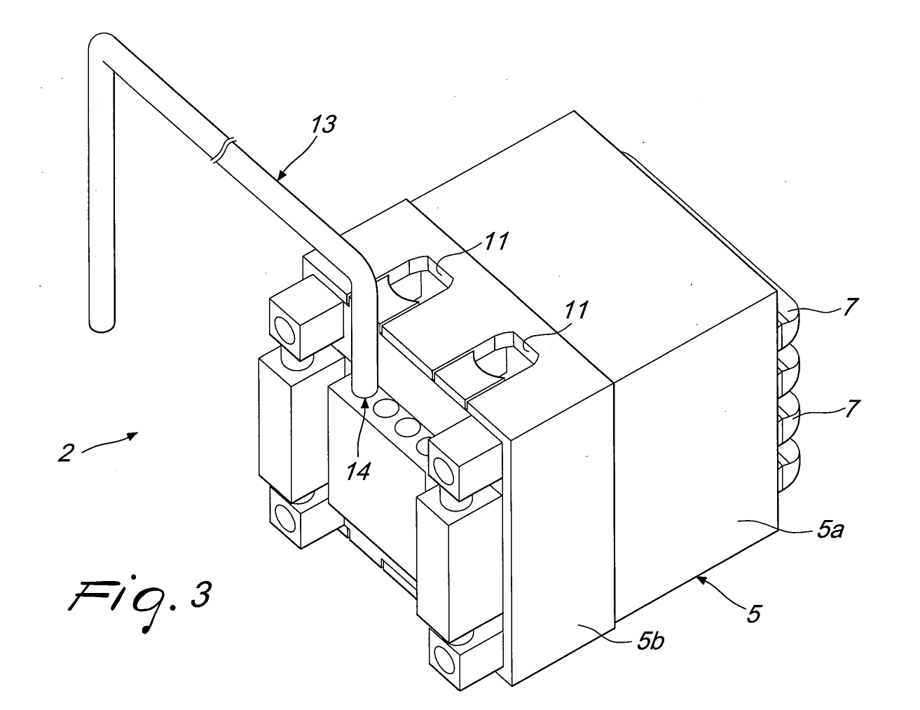

FIG. 4 is a perspective view of the rear half-shell of the main body shown in FIG. 2;

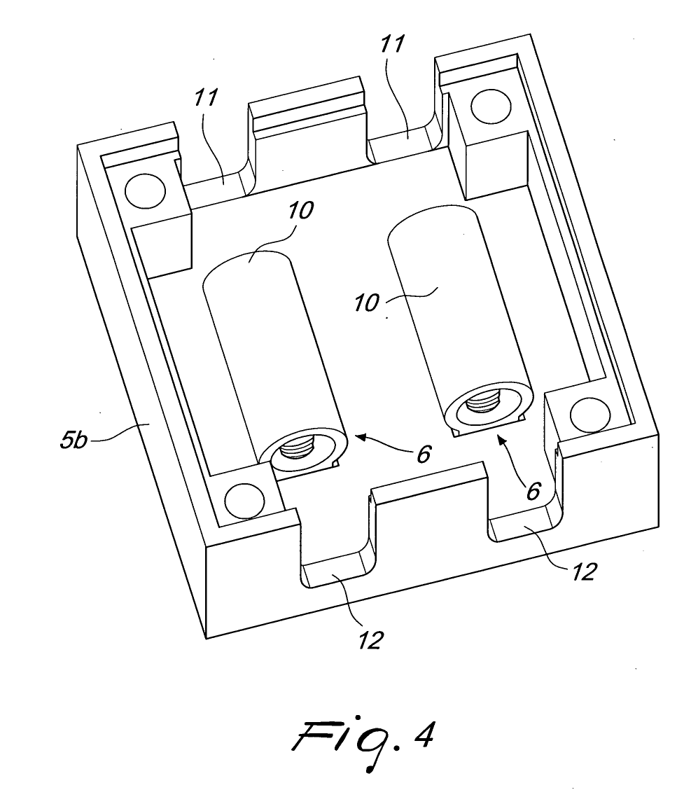

FIG. 5 is a perspective view of the front half-shell of the main body shown in FIG. 2.

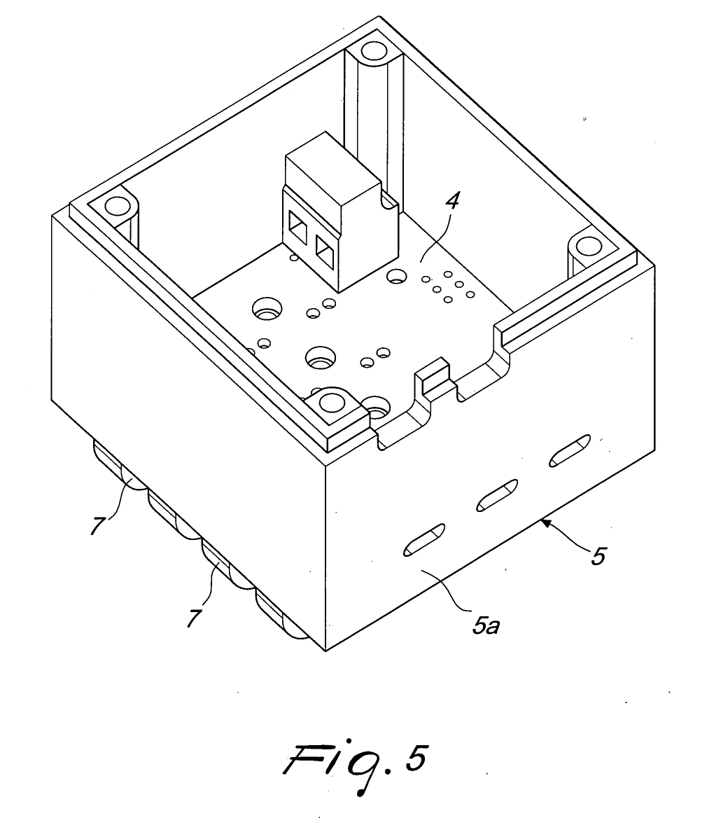

### DETAILED DESCRIPTION OF THE INVENTION

With reference to the figures, the LED luminous screen, particularly for mega screens, generally designated by the reference numeral 1, comprises a plurality of pixels 2 arranged according to an array, each formed by a plurality of LEDs 3 associated with a printed circuit 4 contained in a main body 5 that defines the structure of the individual pixel 2.

More precisely, each main body 5 comprises a front half-shell 5a, which forms at least one opening for the connection of the LEDs 3, and a rear half-shell 5b, which forms the means 6 for fixing the main body to a structure for supporting the screen 1.

Advantageously, the front half-shell 5a forms, proximate to the opening of the LEDs 3, visor elements 7 to avoid unwanted reflections and ensure correct contrast so as to generate an image that can be viewed from a distance.

According to the invention, for each column of the array the supporting structure of the screen 1 comprises at least one supporting cable 8, which can be fixed to each one of the main bodies 5 that belong to the same row of the array by way of fixing means 6 and extend substantially at right angles with respect to an upper supporting bar 9 that can be arranged horizontally.

Advantageously, it is possible to provide one or two supporting cables 8 for every two columns or for every column of the array, which act as power supply cables for the printed circuit 4.

The supporting cables 8 are fixed to the generic main body 5 by means of two cylinders 10, which are accommodated in the rear half-shell 5b and connected to an internal wiring, not shown, for the connection of the supporting cables 8 of the printed circuit 4.

More precisely, the supporting cables 8 are inserted slidably within the cylinders 10 to be then locked by screws that form the fixing means 6 and carry the power supply to the printed circuit 4, being connected directly to the internal wiring.

In order to allow the insertion of the two supporting cables 8, the rear half-shell 5b has two upper openings 11 and two corresponding lower openings 12.

Alternatively, the supporting cable 8 can be fixed to the spacer 13, at the same time carrying electric power to the two connected elements.

According to the invention, the main bodies 5 of adjacent columns that belong to the same row are mutually connected by way of connection means, such as for example elastic shape memory means 13, in order to maintain them substantially on a same plane; more precisely, the elastic shape memory means 13 comprise a plurality of C-shaped elements made of elastically flexible material, which can be fixed between each pair of adjacent main bodies 5, with the arms of the C-shaped elements fixed to the rear part 14 of the rear half-shells 5b of the main bodies 5.

Conveniently, the connection means can comprise cables or rigid spacers with an articulation point.

The use of flexible metallic cables to connect the pixels in a vertical direction and of elastic shape memory means to connect the pixels in a horizontal direction further makes it possible, when so desired, to cover surfaces that are rounded both vertically and horizontally.

In summary, the pixel, formed by the set of multiple LED components of different colors (typically but not exclusively red, green, blue), constitutes an individual element which is protected against the effects of weather by an individual box and is clearly distinct from the others.

The individual pixels and therefore the individual protective boxes can be spaced at variable distances along the column depending on the different fixing position selected along the supporting cable or cables and along the row, depending on the dimensions of the horizontal spacers (elastic shape memory or rigid means).

Moreover, the screen provided by means of the net-like structure cited above can be fixed in an upward region to a horizontal pole that contains the electronic components required for the operation of the system.

The pole therefore contains the power supply and electronic control part.

Conveniently, it can be possible to partially open the pole, or it can have partial openings for access to the internally fixed components.

A screen according to the present invention can therefore be provided by one or more poles of the type indicated above (and of the pixel net connected thereto), which are mutually side by side, keeping between the last column of pixels of one structure and the first column of pixels of the subsequent structure always the same pitch between the pixels.

Each pole therefore can have, for transport, the associated net of pixels wound around it, so as to make transport of the screen and its storage extremely simple.

The pole can be arranged in an upper region, in a lower region or laterally (both on the right side and on the left side), tensioning, when needed, the screen by means of cables or the like, connecting it to a supporting surface.

As an alternative, it is possible to fix the pole to the ground and apply the luminous net by means of aerial balloons.

In practice it has been found that the LED luminous screen particularly for mega screens according to the present invention fully achieves the intended aim and objects, since it uses a supporting structure that has a limited weight, because it is formed exclusively by the power supply cables of the LEDs and by C-shaped elastic elements, at the same time avoiding any deformations of the reproduced images caused by curvatures of the screen, since the supporting structure of said screen is sufficiently rigid to keep all the main bodies that form the individual pixels on a same plane.

Another advantage of the LED luminous screen according to the present invention consists in the fact that the main bodies that form the pixels have a simple shape that can be disassembled easily in order to be able to perform maintenance interventions focused exclusively on the involved pixels.

The LED luminous screen, particularly for mega screens, thus conceived is susceptible of numerous modifications and variations, all of which are within the scope of the inventive concept.

All the details may further be replaced with other technically equivalent elements; in practice, the materials used, as long as they are compatible with this specific use, as well as the contingent shapes and dimensions, may be any according to requirements and to the state of the art.

The disclosures in Italian Patent Application no. MI2008A001438, from which this application claims priority, are incorporated herein by reference.

Where technical features mentioned in any claim are followed by reference signs, said reference signs have been included for the sole purpose of increasing the intelligibility of the claims and accordingly said reference signs do not have any limiting effect on the interpretation of each element identified by way of example by said reference signs.

1.-14. (canceled)

15. An LED luminous screen, particularly for mega screens, giant graphical video screens, lighting effects and the like, comprising a plurality of pixels arranged according to an array, each pixel being formed by a plurality of LEDs which are associated with a printed circuit contained in a main body that forms the individual pixel, further comprising, for each column of said array, at least one supporting cable that can be fixed between the main bodies or to each one of said main bodies that belong to the same row of said array by way of fixing means and extend substantially at right angles to an upper supporting bar or tensioned cable which can be arranged horizontally, said main bodies belonging to adjacent columns of said array being mutually connectable by way of connection means in order to keep said main bodies substantially on a same plane.

16. The screen according to claim 15, wherein said connection means are adapted to transmit electric power.

17. The screen according to claim 15, wherein said connection means comprise elastic shape memory means.

18. The screen according to claim 15, wherein said connection means comprise fixed and tensioned cables.

19. The screen according to claim 15, wherein said connection means comprise rigid spacers with an articulation point.

20. The screen according to claim 15, wherein said connection means comprise rigid or flexible spacers which supply, with the transport of current, the two main bodies connected thereto.

21. The screen according to claim 15, wherein each one of said main bodies comprises a front half-shell, which forms at least one opening for the connection of said LEDs and a rear half-shell, which forms said means for fixing to said at least one supporting cable.

22. The screen according to claim 15, further comprising two of said supporting cables for each one of said rows of said array.

23. The screen according to claim 21, wherein said rear half-shell has two upper openings and two corresponding lower openings for the passage of said two supporting cables.

24. The screen according to claim 22, wherein said supporting cables can be inserted in two cylinders which are accommodated inside each one of said main bodies and can be fixed to said supporting cables by means of screws, said cylinders being fixable to said rear half-shell and forming said fixing means.

25. The screen according to claim 17, wherein said elastic shape memory means comprise a plurality of C-shaped elements made of elastically flexible material which can be fixed between each pair of said adjacent main bodies so that the arms of said C-shaped elements are fixed to said rear half-shells of said main bodies.

26. The screen according to claim 21, wherein said two supporting cables are power supply cables of said printed circuit.

27. The screen according to claim 26, further comprising, for each one of said main bodies, an internal wiring for the connection of said power supply cables to said printed circuit.

28. The screen according to claim 15, wherein each one of said main bodies comprises visor means for said LEDs.
